(19) United States
(12) Patent Application Publication
(10) Pub. No.: US 2002/0181235 A1
(43) Pub. Date: Dec. 5, 2002

(54) Decorative globes

(75) Inventor: Wing Leung, Quarry Bay (CN)

Correspondence Address: ALIX YALE & RISTAS LLP, 750 MAIN STREET, SUITE 1400, HARTFORD, CT, 06103, US

(73) Assignee: Green Logic Associates limited

(21) Appl. No.: 09/873,845

(22) Filed: Jun. 4, 2001

(51) Int. Cl. F21V 1/00

(52) U.S. Cl. 362/286

(57) ABSTRACT

An illuminated decorative globe has an outer translucent cover 10 forming an enclosure to an inner globe 11. The inner globe is supported on a rotatable frame 13 and a light bulb 15 is mounted inside the globe. A surface of the globe carries an image, such as a world map, that is projected onto the surface of the cover and visible from outside the cover. The image is swept around the cover as the frame is rotated by an electric motor 16.

### BACKGROUND OF THE INVENTION

1. Field of the Invention

The invention relates to decorative globes.

2. Description of Prior Art

Decorative globes, typically for standing on a work top or a casual table, are already known. Such globes often incorporate a light that illuminates the globe from inside so that a patterned or colored lamp is provided for general illumination. The globe may carry simply wording, advertising slogans, trade marks and the like. The light may also be arranged to flash or be arranged to turn OFF automatically during daylight hours so the globe could be used as for a traffic signal, at a pedestrian crossing say. Whilst many such known globes can have utilitarian functions, the globes are typically aesthetically or strikingly colored and are in any event referred to herein as “decorative globes”.

It has so far not been proposed to provide globes have moving patterns, or signs, that could also be utilitarian and even educational.

### SUMMARY OF THE INVENTION

It is an object of this invention to overcome this problem.

According to the invention there is provided an illuminated decorative globe having an outer translucent cover forming an enclosure for an inner globe carrying an image on its surface, a rotatably mounting supporting the inner globe and an electric light bulb inside the inner globe, and an electric motor coupled to rotate the mounting such that the image is projected onto an inner surface of the outer cover and is visible from outside the outer cover.

The outer cover and inner globe may both be spherical.

The outer cover preferably has an aperture in its base through which the inner globe may pass during assembly of the decorative globe.

The image may be a map of the world or a part of the world.

### BRIEF DESCRIPTION OF THE DRAWINGS

A decorative illuminated globe according the invention will now be described by way of example with reference to the accompanying drawings in which:

FIG. 1 is a sectional elevation of the globe;

FIG. 2 is a schematic view of the globe; and

FIG. 3 is an isometric view of an inner part of the globe.

### DESCRIPTION OF THE PREFERRED EMBODIMENTS

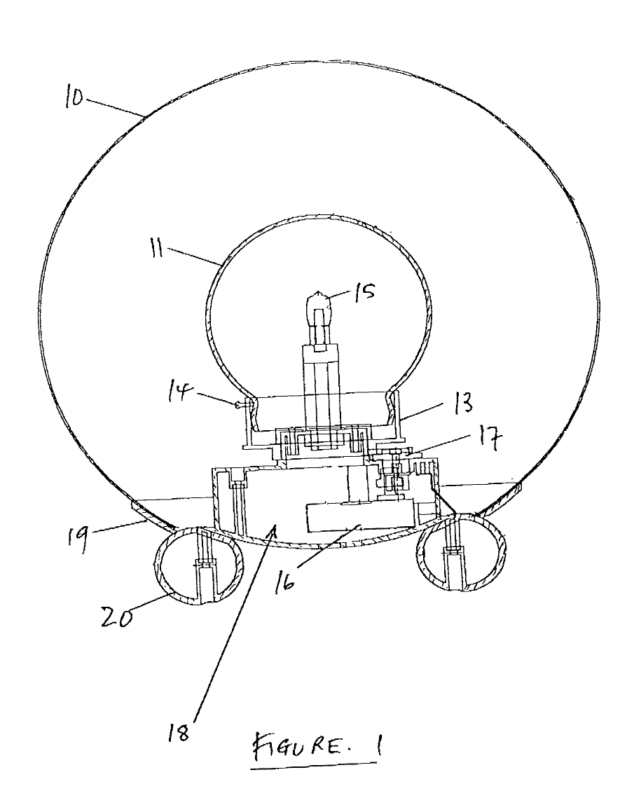

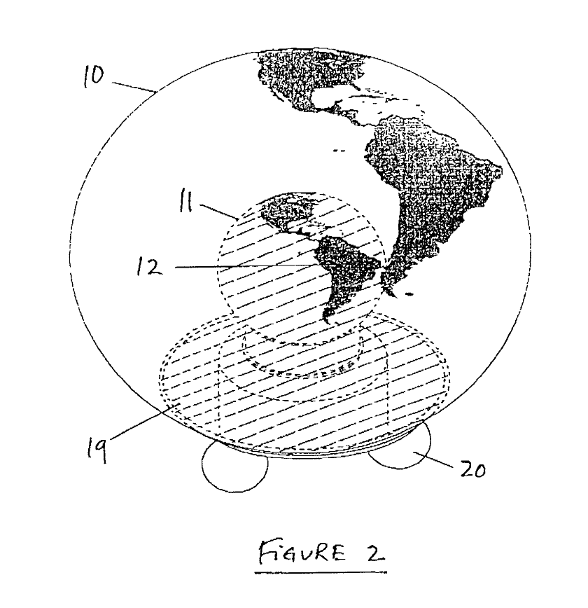

Referring to the drawings, in FIG. 1 a spherical outer translucent cover 10 forms an enclosure for a spherical inner globe 11. An outer surface of the globe carries an image 12 of a World map (partially shown in FIG. 2). The inner globe is supported by a rotatable frame 13 and held in position by a screw 14. A light bulb 15 is also supported by the frame 13 at the centre of the inner globe. An electric motor 16 is coupled by gears 17 to the frame 13 and arranged to rotate the inner globe 11 when the motor is turned ON. As a result the image of the world map is projected onto an inner surface of the outer cover 10 for viewing from outside the outer cover 10, as will be clear from FIG. 2.

The outer cover and the inner globe are both spherical in the described embodiment which is preferable when the image is a representation of a specific ‘picture’, such as a map. Even so, other shapes of covers and globes may be used; other shapes may be aesthetically preferred where the projected image is simply a colored pattern, for example.

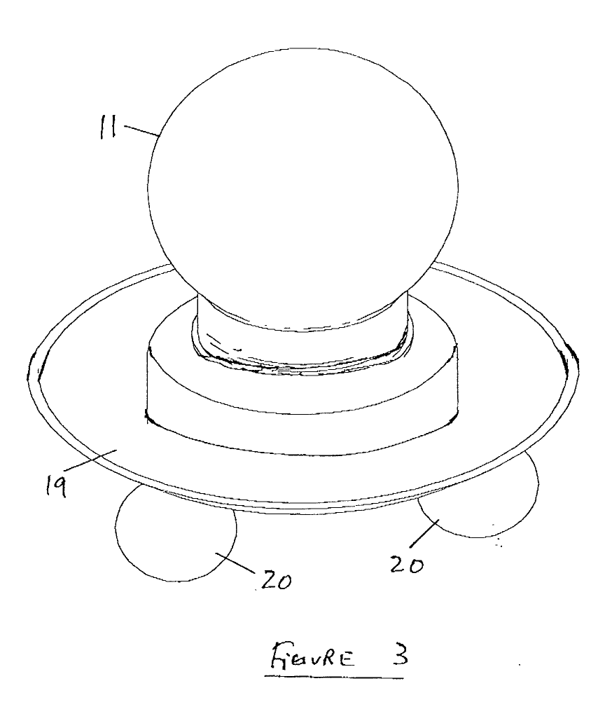

In FIG. 3, the outer cover 10 has been removed to allow the inner globe to be changed or cleaned. The globe may be lifted off the frame 13 for servicing or changing the light bulb. Importantly, it will be noted that the outer cover has a lower aperture 18 (see FIG. 1) to allow easy removal of the cover; the cover being simply supported on a stand 19. The stand has three evenly distributed feet 20, only two of which are visible in the Figures.

Thus, in normal use the image 12 is projected to sweep around the outer cover 10 and overall the decorative globe may be used for some general illumination at the same time. The outer cover 10 may carry vertical marking (“longitudinal lines”) and the inner globe arranged to rotate completely every twenty-four hours so that the described globe can provide a ‘world’ time piece.

I claim

1. An illuminated decorative globe having an outer translucent cover forming an enclosure for an inner globe carrying an image on its surface, a rotatably mounting supporting the inner globe and an electric light bulb inside the inner globe, and an electric motor coupled to rotate the mounting such that the image is projected onto an inner surface of the outer cover and is visible from outside the outer cover.

2. An illuminated decorative globe according to claim 1, in which the outer cover and inner globe are spherical.

3. An illuminated decorative globe according to claim 1, in which the outer cover has an aperture in its base through which the inner globe may pass during assembly of the decorative globe.

4. An illuminated decorative globe according to claim 1, in which the image is a map of the world.
